(19) United States
(12) Patent Application Publication
(10) Pub. No.: US 2013/0113199 A1
(43) Pub. Date: May 9, 2013

(54) DOUBLE POSTCARD CHECK WITH ADDRESS CORRECTION FORM AND METHOD OF USE THEREOF

(71) Applicants: Daniel Rosenthal, Ross, CA (US); Gerard Mullins, Hermosa Beach, CA (US); Benito Aguilar, N Oswego, IL (US)

(72) Inventors: Daniel Rosenthal, Ross, CA (US); Gerard Mullins, Hermosa Beach, CA (US); Benito Aguilar, N Oswego, IL (US)

(73) Assignee: KURTZMAN CARSON CONSULTANTS, LLC, Novato, CA (US)

(21) Appl. No.: 13/288,277

(22) Filed: Nov. 3, 2011

(51) Int. Cl. B42D 15/00

(52) U.S. Cl. 283/67; 283/58

(57) ABSTRACT

A double postcard check mailer and a method of use therefore are described. The mailer is comprised of a check component and a payee data correction component detachably coupled to the check component. The mailer, when folded, has the dimensions of a double postcard. The mailer is sent to the payee of the check. The payee detaches the check component from the payee data correction component and cashes the check component. The payee further fills out the payee data correction component with updated information, such as a corrected address, and deposits the completed payee data correction component in the mail with postcard shipping postage. The original sender of the mailer receives the payee data correction component and updates the payee's information based on the data received in the completed payee data correction component.

### FIELD

The present disclosure relates to a double postcard check mailer including a check component and a payee data correction component and a method of use therefor.

### BACKGROUND

This section provides background information related to the present disclosure which is not necessarily prior art.

There are many legal proceedings and settlements that result in the need for the distribution of cash proceeds and related information to a plurality of recipients. Typical examples of such proceedings are class action litigation proceedings and bankruptcy proceedings. The number of recipients may be in the thousands or more. An administrator of the proceedings often distributes the funds to the recipients. The administrator may transmit the funds to the recipients by placing a check made out to the recipient in an envelope, paying the applicable postage (e.g., first class letter rate), and sending the check to the recipient via the federal mail system. If information regarding the recipient changes, e.g., a change of address or name, the recipient would have to initiate a telephone call or send a letter requesting such a change be made to the administrator's records.

### SUMMARY

This section provides a general summary of the disclosure, and is not a comprehensive disclosure of its full scope or all of its features.

In one aspect of the disclosure, a mailing apparatus is disclosed. The mailing apparatus comprises a check component including a check having a front side and a back side. The front side includes a payee field, a maker field, a written amount field, an account number field, a routing number field, and a numeric amount field. The back side includes an endorsement line. The mailing apparatus further comprises a payee data correction component detachably coupled to the check component. The payee data correction component includes a payee data correction form having a front side and a back side. The front side includes a maker address field in a substantially central or right-central area of the front of the payee data correction form, and a payee data correction field at a substantially top left portion of the front of the payee data correction form. The top front edge of the check folds downwardly towards the bottom front edge of the payee data correction component, such that when the mailing apparatus is folded, the back of the check and the back of the payee data correction form are external and the front of the check and the front of the payee data correction from are internal.

In another aspect of the disclosure, a method of administering distribution of funds in one of a legal proceeding, a class action litigation proceeding and a bankruptcy proceeding is disclosed. The method comprises receiving a name of a payee and payee data, wherein the payee is one of a plurality of claimants in the proceeding. The payee data includes at least one of a mailing address and contact information of the payee, and the payee is owed at least one future payment through the one of the class action proceeding and the bankruptcy proceeding. The method further comprises storing the name of the payee and the payee data in a database and generating a mailer based on an amount of one of the at least one future payment. The name of the payee, and the payee data, the mailer including a check component and a payee data correction component detachably coupled to the check component. When the mailer is folded, the mailer has dimensions in compliance with U.S. Postal Regulations governing the applicability of postcard postage rates. The method further comprises applying a predetermined amount of postage to the mailer, the predetermined amount being in compliance with the postcard shipping rates. The method also includes sending the mailer to the payee, paying funds to the payee once the payee cashes the check component, and receiving the payee data correction component from the payee. The payee data correction component includes at least one of a corrected name of the payee and a corrected address of the payee. The method also comprises updating at least one of the stored name of the payee and the stored payee data in the database based on the corrected name of the payee and the corrected address of the payee received in the payee data correction component.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a drawing illustrating a perspective front view of a front side of a mailer having a check component and a payee data correction component, according to some embodiments of the present invention;

FIG. 2 is a drawing illustrating a perspective rear view of a back side of the mailer having a check component and a payee data correction component, according to some embodiments of the present invention;

FIG. 3 is a drawing illustrating a perspective front view of the mailer being folded, according to some embodiments of the present invention;

FIG. 4 is a drawing illustrating a perspective front view of the mailer after the mailer has been folded, according to some embodiments of the present invention;

FIG. 5 is a drawing illustrating a perspective front view of the mailer as it is being opened, according to some embodiments of the present invention;

FIG. 6 is a drawing illustrating a perspective front view of the mailer being unfolded, according to some embodiments of the present invention;

FIG. 7 is a drawing illustrating a perspective front view of the mailer as the check component is being detached from the payee data correction component, according to some embodiments of the present invention; and

FIG. 8 is a method illustrating a method of use for the mailer, according to some embodiments of the present invention.

Corresponding reference numerals indicate corresponding parts throughout the several views of the drawings.

### DETAILED DESCRIPTION

Example embodiments will now be described more fully with reference to the accompanying drawings.

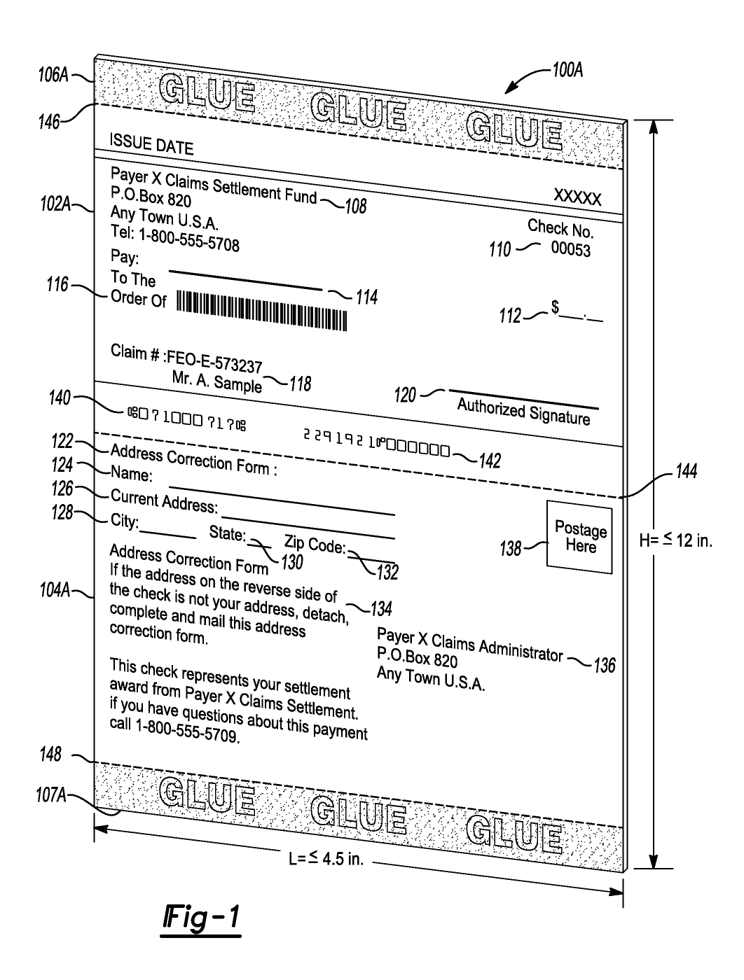

FIG. 1 illustrates the front side 100A of a mailing apparatus, or mailer 100. The mailer 100 is comprised of a check component 102, the front side 102A of which is shown in FIG. 1, and a payee data correction component 104, the front side 104A of which is shown as well in FIG. 1. The check component 104 is comprised of a check that is made out to the payee from the maker. It is appreciated that the payee may be a recipient or claimant in a proceeding, such as a class action or bankruptcy proceeding.

The check component 102 is comprised of a first tab 106, a maker field 108, a check number field 110, a numeric amount field 112, a payee field 116, a written amount field 114, a memo field 118, a maker signature field 120, a routing number field 140, and an account number field 142. It is appreciated that the provided layout of the front side 102A of the check component 102 is exemplary and that other layouts are contemplated and are within the scope of this disclosure.

The front side 104A of the payee data correction component 104 is comprised of a payee data correction field 122, which may include a name field 124, a current address field 126, a city field 128, a state field 130, a postal code field 132 and, if required, a country field. The front side 104A of the payee data correction component 104 further comprises an instruction field 134, a maker address field 136, a postage area 138, and a second tab 107, the front side 107A of which is shown in FIG. 1.

In some embodiments, the dimensions of the mailer 100 are selected such that the mailer 100 can be mailed using postcard shipping rates, as may be defined by United States Postal Regulations. As distributions in a class-action litigation proceeding or bankruptcy proceeding may be incremental distributions in smaller amounts, e.g., $10.00 or less, the postcard shipping rates reduce the overall overhead associated with the distribution of funds. In an example embodiment, the height of the mailer is less than 8½ inches, such that when the mailer 100 is folded, the mailer 100 is less than or equal to 4¼ inches in height. Similarly, the width of the mailer 100 is less than or equal to 6 inches. The example embodiment can be tailored within dimension restrictions established by the United States Post Office.

As will be discussed in further detail below, the mailer 106 is folded such that the front side 106A of the first tab 106 and the front side 107A of the second tab 107 are pressed together thereby sealing the mailer 100. It is appreciated that other means for fastening the mailer when folded are also contemplated and within the scope of this disclosure. For example, a tab or sticker may be used to seal the mailer 100 after folding.

Referring back to the individual components of the front side 102A of the check component 102, the fields provided in the example are fields that may be used to generate a check. For example, the maker field 108 identifies the maker of the check. In this example, the maker of the check 102 is “Payer X Claims Settlement Fund” located in Anytown, USA at P.O. Box 820. Additional information such as a telephone number or other information can also be provided in this field. The check number field 110 identifies a number of the check 102. The numeric amount field 112 indicates a numeric amount of the check 102, i.e., the amount of funds to be distributed to the payee. The written amount field 114 identifies the amount of funds to be distributed in a written format. The payee field 116 identifies the identity of the entity to which the funds identified in the written amount and numeric amount fields 112 and 114 are to be distributed. The memo field 118 indicates a note or memo from the maker. For example, a number identifying the exact payment that is being made. The authorized signature field 120 provides an area for the maker or a representative of the maker to execute or sign. The routing number field 140 indicates a routing number corresponding to the bank issuing the check. The account number field 142 indicates an account from which the funds identified in field 112 and 116 are to be withdrawn from to distribute to the payee.

Referring now to the payee data correction component 104, the payee data correction component 104 can be used by the payee to update information of the payee so as to allow for more efficient distribution of future correspondence or payments to the payee. For example, if the payee has moved, and is receiving address forwarding services, the mailer 100 may arrive to the payee as a result of address forwarding. In the case where multiple payments are made or other future correspondences or legal papers are sent to the payee, the payee data correction form 104 allows the payee to update his or her information for subsequent distributions and/or other future correspondences, even after the address forwarding service has stopped.

The payee data correction field 122 is located at the top left corner of the front of the front side 104A of payee data correction component 104. As will be described later, the payee data correction component 104 is detached from the check component 102 to form a postcard that can be sent to the maker listed in the maker address field 136. The placement of the maker address field 136 can be at the position where an address is typically found in a postcard. The address correction field 122 can be located at the position where the return address of the sender is typically found on a postcard.

In operation, a payee sending back the address correction component 104 would provide his or her name in the name field 124, his or her current address in the address field 126, his or her city in the city field 128, his or her state in the state field 130, and his or her zip code in the postal code field 132. It is appreciated that the name field 124 may be pre-printed to include the payee's name on the form prior to an initial mailing of the mailer 100 to the payee. The payee would then place an appropriate amount of postage onto the postage field 138 and would deposit the postcard in the mail, which would be forwarded to the maker. The maker can receive the payee data correction form 104 and can update a database listing a plurality of recipients with the updated payee data.

In some embodiments, the check component 102 and the payee data correction component 104 are detachably coupled. This can be achieved by having a first perforated line 144 across a horizontal axis of the mailer 100. Further, a second perforated line 146 can detachably couple the first tab 106 to the check portion of the check component 102, and a third perforated line 148 can detachably couple the second tab 107 to the payee data correction form of the payee data correction component 104.

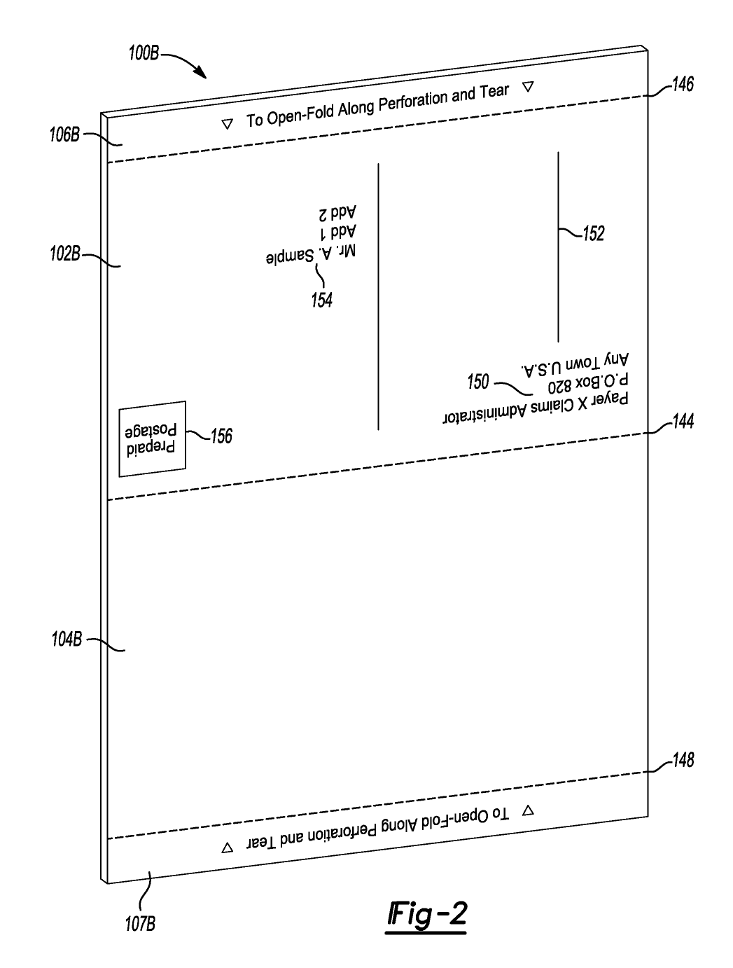

FIG. 2 illustrates the back side 100B of the mailer 100. The back side 100B of the mailer 100 is comprised of the back side 102B of the check component 102 and the back side 104B of the payee data correction component 104. The back side 102B of the check component 102 is comprised of a return address field 150, an endorsement line 152, a payee address field 154, and a prepaid postage field 156. Furthermore, the check component 100 may include the first tab 106 and the second tab 107, the backs 106B and 107B of which are shown in FIG. 2. As previously discussed, the mailer is folded and fastened by glue or other fastening means by the tabs 106 and 107. When folded, the back of the check component 102B will be externally facing such that the check amount and the information on the front side 102 of the check component 102 is kept confidential from the handler of the mailer 100.

The back 102B of the check component 102 includes a return address field or maker return address field 150 which indicates a return address of the maker and a payee address field 154 which indicates an address of the payee. As the mailer 100 is folded into a postcard, the deliverer of the mailer 100 will use the payee address field 154 to deliver the mailer to the intended recipient. The endorsement line 152 is where the payee would sign and endorse the check 102 to allow distribution of the funds thereto. It is appreciated that in FIG. 2, the characters of the back side 102B of the check component 102 are shown upside-down. This is so when the mailer 100 is folded, the writing on the backside 102B of the check 102 appears right side up and the endorsement line 152 appears on the correct end of the check 102. It is appreciated, however, that other configurations of the back side 102B of the check 102 are contemplated within the scope of the disclosure. For instance, the prepaid postage field 156 and the maker return address field 150 could be located at the top of the back 102B of the check component 102 and the payee address field 154 may be at the middle right and towards the bottom of the back side 102B of the check component 102. In the example provided, there is no additional data provided on the back of the payee data correction form 104B. It is appreciated, however, that additional fields may be provided where the payee can edit other types of data in addition to the name and address of the payee.

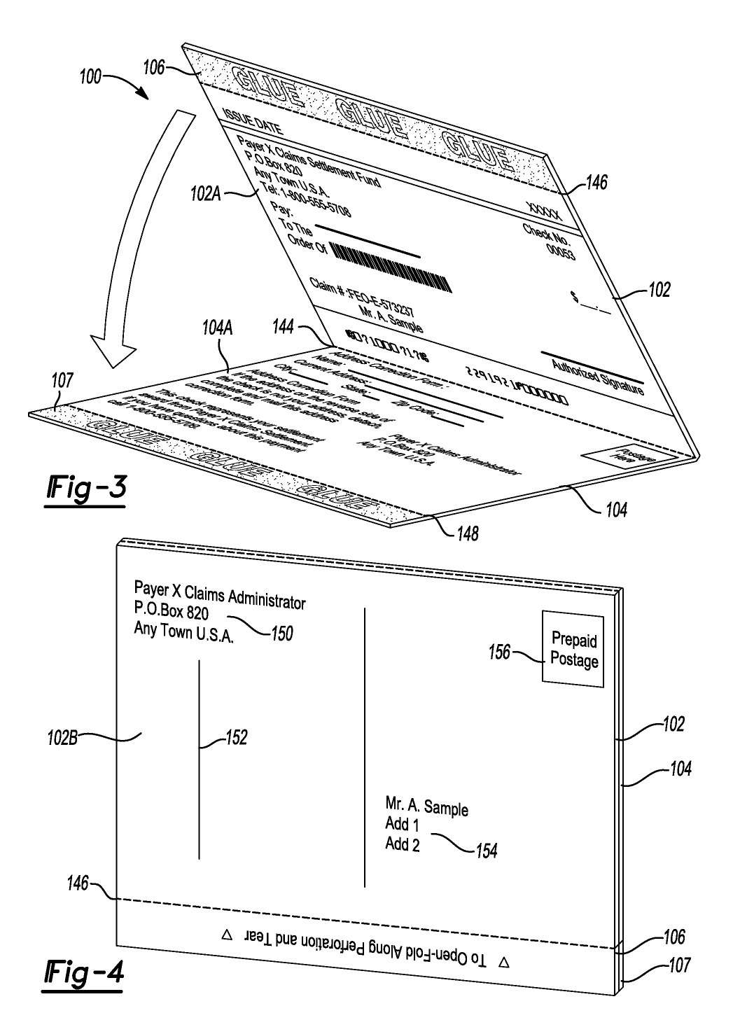

FIG. 3 illustrates the mailer 100 being folded. As can be appreciated, the mailer 100 is being folded such that the first tab 106 and the second tab 107 are glued together. The front side 102A of the check component 102 is folded downwardly towards the front side 104A of the payee data correction component 104.

FIG. 4 illustrates the mailer 100 after the first tab 106 and the second tab 107 have been secured to one another. As can be appreciated, the mailer 102 has the form of a post card, such that the maker return address field 150 appears at the top-left section of the back side 102B of the check 102 and perpendicular to the endorsement line 152. The payee address field 154 appears in the front-center or front-right-center portion of the back side 102B of the check component 102. After sealing, the mailer 100 may be deposited in the mail to the payee.

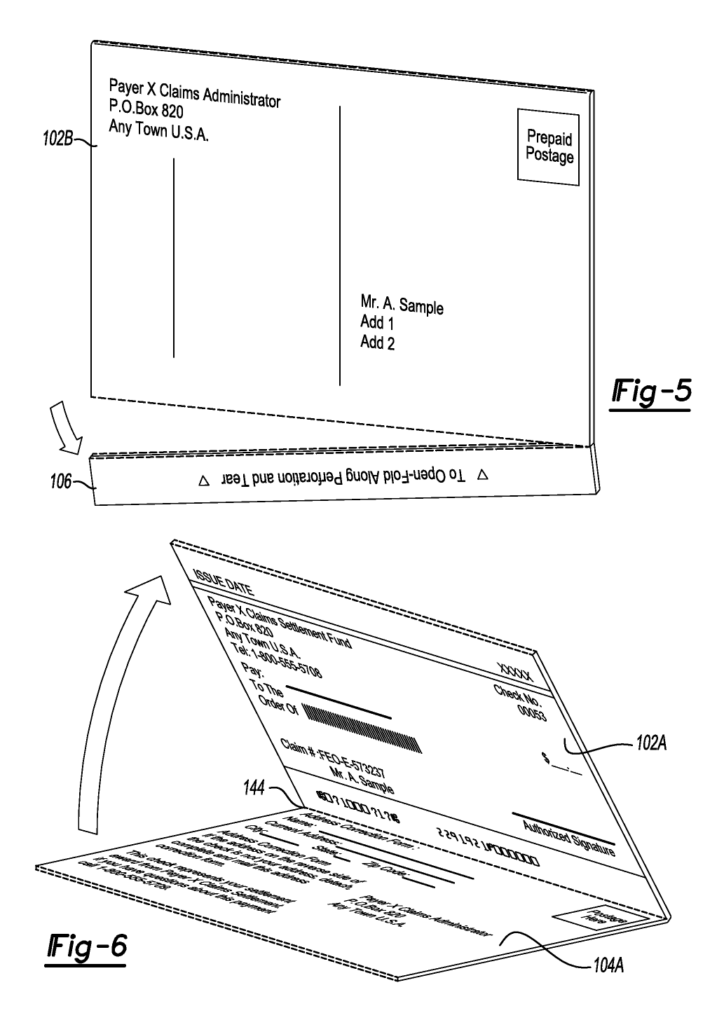

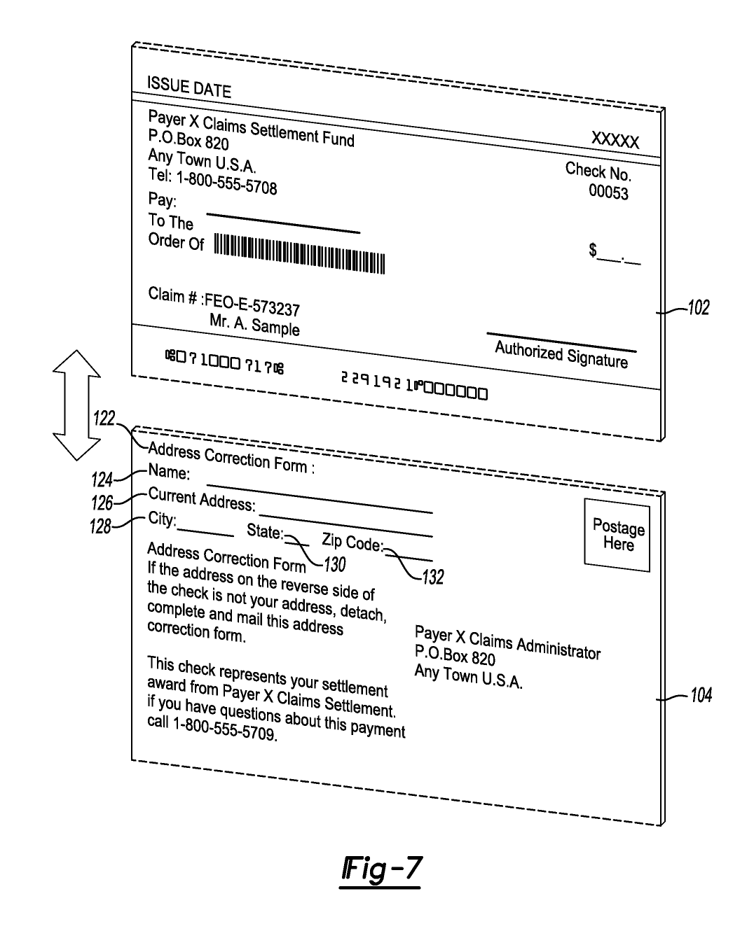

FIGS. 5, 6, and 7 illustrate the mailer 100 being opened. In FIG. 5, a user may detach the tabs 106 and 107 (not shown) from the check component 102 and the payee data correction component 104 (not shown). As shown in FIG. 6, the user can separate the top of the check component 102 from the bottom of the payee data correction form 104. As shown in FIG. 7, the payee can detach the payee data correction component 104 from the check component 102 by pulling the two components 102 and 104 apart. The payee can correct his or her information by filling out the payee data correction field 122. In doing so, the payee merely provides his or her name 124, current address 126, city 128, state 130 and postal code 132. The payee further provides sufficient postage in the postage area 138, and deposits the payee data correction component 104 in the mail.

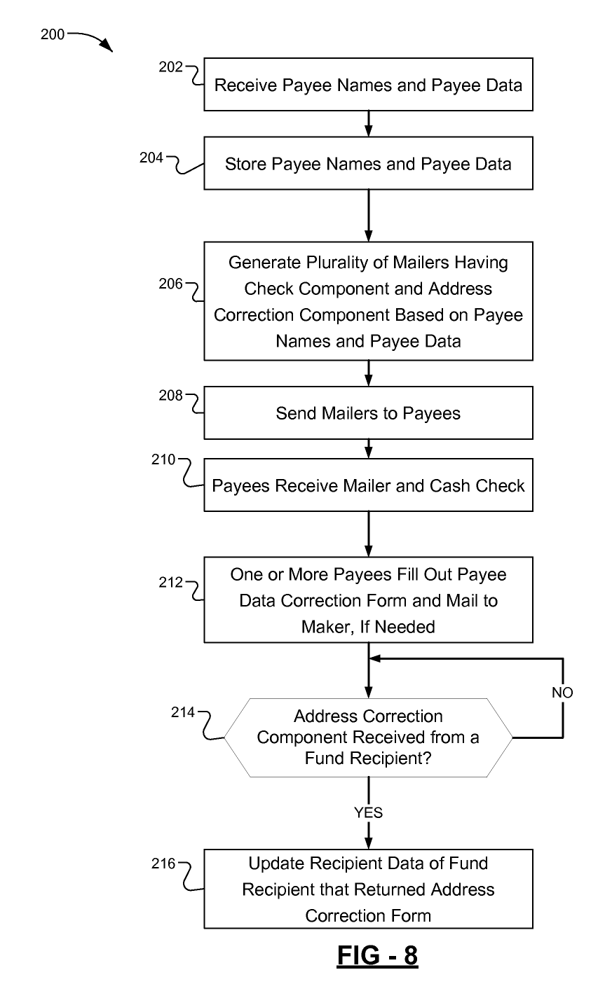

FIG. 8 illustrates a method 200 for distributing funds to a claimant or fund recipient. At step 202, an administrator of a fund, such as an administrator of a class action lawsuit or bankruptcy proceeding, or a similar entity will receive a list of payees and associated payee data. It is appreciated that the payees are people or entities that are to have funds distributed thereto. Payee data can include an address, a city, a state, and a postal code of the payee and may further include information such as a telephone number, a current payment amount for the amount of funds to be distributed to the payee, a total payment amount for the amount of funds to be distributed to the payee, and/or a frequency of the distribution of funds.

At step 204, the list of payees and the associated payee data may be stored in a database (not shown). At step 206, a plurality of mailers are generated, each mailer 100, being in substantially the form and format described above, and including a check component 102 and payee data correction component 104. The database contents can be used when the mailer 100 is generated to provide the specific data for each mailer 100 that is to be sent to each payee. For example, for a first mailer 100, a printing module (not shown) may retrieve a name of a payee, the address of the payee, and the amount to be distributed. The retrieved information can be used to generate the mailer 100, by way of a template, for example. Thus, the information contained on the check component and the payee correction component is based on the payee data.

Once all the mailers are generated, the mailers 100 are sent by mail to the payees, as shown at step 208. At step 210, the mailers 100 are received and cashed by the individual payees. Upon receiving the mailers, the payees detach the check component 102 from the payee data correction component 104, and deposit or otherwise cash the check component 102 at a bank or other check cashing institution. If one or more of the payees determines that the payee data indicated on the mailer 100 is incorrect, the one or more payees will remove and fill out the payee data correction component 104, apply the appropriate postage thereto, and deposit the payee data correction component 104 in the mail, as shown at step 212.

After the mailers 100 have been sent, the administrator (maker) waits for any payee data correction components 104 to be received, as shown at step 214. When such a component 104 is received, the payee data of that payee providing the payee data correction component 104 is updated in the database based on the information contained in the payee data correction component 104, as shown at step 316.

It is appreciated that the foregoing method may be performed continuously until all the funds of a proceeding are distributed to the payees. It is appreciated that this method may also be executed at each round of distributions, such that with each round of distributions the administrator can update the information of a payee upon receiving the payee correction form.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A mailing apparatus comprising:
a check component including a check having a front side and a back side, the front side including a payee field, a maker field, a written amount field, an account number field, a routing number field, and a numeric amount field, the back side including an endorsement line; and
a payee data correction component detachably coupled to the check component, the payee data correction component including a payee data correction form having a front side and a back side, the front side including a maker address field in a substantially central or right-central area of the front of the payee data correction form, and a payee data correction field at a substantially top left portion of the front of the payee data correction form,
wherein the top front edge of the check folds downwardly towards the bottom front edge of the payee data correction component, such that when the mailing apparatus is folded, the back of the check and the back of the payee data correction form are external and the front of the check and the front of the payee data correction from are internal.

2. The mailing apparatus of claim 1 wherein the check component has a width less than or equal to four and a half inches and a height less than or equal to 6 inches, and wherein the payee data correction component has a width less than or equal to four and a half inches and a height less than or equal to 6 inches.

3. The mailing apparatus of claim 1 wherein the back of the check includes a payee address field in a substantially central or upper-left-central area of the back of the check and indicating an address of the payee, a maker return address field at a substantially bottom right portion of the back of the check and indicating a return address of the maker, wherein when the mailing apparatus is folded the back of the check contains information for mailing the mailing apparatus to the payee.

4. The mailing apparatus of claim 3 wherein the mailing address field is substantially perpendicular to the endorsement line.

5. The mailing apparatus of claim 1 further comprising fastening means for fastening the top edge of the front of the check to the bottom edge of the front the payee data correction form.

6. The mailing apparatus of claim 1 wherein the check component includes a first tab detachably coupled to the top edge of the front of the check and wherein the payee data correction component includes a second tab detachably coupled to the bottom edge of the front of the payee data correction form.

7. The mailing apparatus of claim 6 wherein at least one of the first tab and the second tab is coated with glue, such that when the mailing apparatus is folded the first tab and the second tab are glued together, thereby sealing the mailing apparatus.

8. The mailing apparatus of claim 1 wherein the payee is one of a plurality of recipients in one of a class action proceeding and a bankruptcy proceeding.

9. The mailing apparatus of claim 8, wherein the payee provides at least one of an updated name and an updated address to the maker by detaching the payee data correction component from the check, and inserting at least one of the updated name and the updated address in the payee data correction field, and mailing the payee correction component to the maker using postcard shipping rates.

10. The mailing apparatus of claim 9 wherein the maker receives the payee data correction component and updates a payee data entry with the at least one of the updated name and the updated address indicated in the payee data correction field.

11. A method of administering distribution of funds in one of a legal proceeding, a class action litigation proceeding and a bankruptcy proceeding, the method comprising:
receiving a name of a payee and payee data, wherein the payee is one of a plurality of claimants in the proceeding, wherein the payee data includes at least one of a mailing address and contact information of the payee, and wherein the payee is owed at least one future payment through the one of the class action proceeding and the bankruptcy proceeding;
storing the name of the payee and the payee data in a database;
generating a mailer based on an amount of one of the at least one future payment, the name of the payee, and the payee data, the mailer including a check component and a payee data correction component detachably coupled to the check component, wherein when the mailer is folded, the mailer having dimensions in compliance with U.S. Postal Regulations governing the applicability of postcard postage rates;
applying a predetermined amount of postage to the mailer, the predetermined amount being in compliance with the postcard shipping rates;
sending the mailer to the payee;
paying funds to the payee once the payee cashes the check component;
receiving the payee data correction component from the payee, the payee data correction component including at least one of a corrected name of the payee and a corrected address of the payee; and
updating at least one of the stored name of the payee and the stored payee data in the database based on the corrected name of the payee and the corrected address of the payee received in the payee data correction component.

12. The method of claim 11 wherein the check component includes a check having a front side and a back side, the front side including a payee field, a maker field, a written amount field, an account number field, a routing number field, and a numeric amount field, the back side including an endorsement line.

13. The method of claim 12 wherein the payee data correction component includes a payee data correction form having a front side and a back side, the front side including a maker address field in a substantially central or right-central area of the front of the payee data correction form, and a payee data correction field at a substantially top left portion of the front of the payee data correction form,
wherein the top front edge of the check folds downwardly towards the bottom front edge of the payee data correction component, such that when the mailer is folded, the back of the check and the back of the payee data correction form are external and the front of the check and the front of the payee data correction form are internal.

14. The method claim 13 wherein the back of the check includes a payee address field in a substantially central or upper-left-central area of the back of the check and indicating an address of the payee, a maker return address field at a substantially bottom right portion of the back of the check and indicating a return address of the maker, wherein when the mailer is folded the back of the check contains information for mailing the mailer to the payee.

15. The method of claim 14 wherein the dimensions of the mailer include a height that is less than or equal to four and a half inches and a width that is less than or equal to six inches.

16. The method of 13 further comprising folding the top of the check component downwardly towards the bottom of the payee data correction component and fastening said tope of the check component to the bottom of the payee data correction component.

17. The method of claim 16 wherein the check component includes a first tab detachably coupled to the top edge of the front of the check and wherein the payee data correction component includes a second tab detachably coupled to the bottom edge of the front of the payee data correction form, wherein the first tab is fasted to the second tab using a glue strip.

18. The method of claim 11, wherein the payee provides at least one of the corrected name of the payee and the corrected address of the payee in the payee data correction component and mails the payee correction component to the maker using postcard shipping rates.

19. The method of claim 11 further comprising sending subsequent correspondence or fund distributions to the payee using the corrected payee data.
